(19) United States
(12) Patent Application Publication
(10) Pub. No.: US 2026/0155598 A1
(43) Pub. Date: Jun. 4, 2026

(54) CHARGER DEVICE AND CASING WITH A REINFORCING RIB STRUCTURE

(71) Applicant: LITE-ON TECHNOLOGY CORPORATION, TAIPEI CITY (TW)

(72) Inventors: Wei-Chih Chen, TAIPEI CITY (TW); CHEN-CHIA WU, TAIPEI CITY (TW); CHI-MO HUANG, TAIPEI CITY (TW)

(21) Appl. No.: 19/012,813

(22) Filed: Jan. 7, 2025

(30) Foreign Application Priority Data
Dec. 3, 2024 (CN) 202411759217.0

(51) Int. Cl. H01R 13/502

(52) U.S. Cl. CPC H01R 13/502

(57) ABSTRACT

A charger device includes a casing, two conductive members, and a holder. The casing includes a first through hole, a second through hole, and a reinforcing rib structure. The first through hole and the second through hole are interconnected to an accommodating space inside the casing. The reinforcing rib structure is disposed inside the casing. The reinforcing rib structure includes a longitudinal rib. The longitudinal rib is disposed between the first through hole and the second through hole. An extending direction of the longitudinal rib is parallel to a connecting line connecting the first through hole and the second through hole.

### CROSS-REFERENCE TO RELATED PATENT APPLICATION

This application claims the benefit of priority to China Patent Application No. 202411759217.0, filed on Dec. 3, 2024, in the People's Republic of China. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a charger device and a casing, and more particularly to a charger device and a casing with a reinforcing rib structure.

### BACKGROUND OF THE DISCLOSURE

To comply with safety regulations, existing charger devices need to undergo structural strength testing during the manufacturing process. For example, the charger devices undergo a tumbling test to check for any breakage or detachment of components of the charger devices. In the related art, to ensure that the charger devices meet safety standards and to prevent breakage after repeated uses, the structural strength of the charger devices can be strengthened by increasing the amount of structural materials. However, due to this approach of increasing the amount of structural materials, the manufacturing costs are increased, and the product's competitiveness is reduced.

Therefore, how to overcome the above-mentioned problem through an improvement in structural design has become an important issue to be addressed in the related art.

### SUMMARY OF THE DISCLOSURE

In response to the above-referenced technical inadequacy, the present disclosure provides a charger device and a casing with a reinforcing rib structure.

In order to solve the above-mentioned problems, one of the technical aspects adopted by the present disclosure is to provide a casing with a reinforcing rib structure, which includes a first through hole, a second through hole, and a reinforcing rib structure. The first through hole and the second through hole are interconnected to an accommodating space inside the casing. The reinforcing rib structure is disposed inside the casing. The reinforcing rib structure includes a longitudinal rib, the longitudinal rib is disposed between the first through hole and the second through hole, and an extending direction of the longitudinal rib is parallel to a connecting line connecting the first through hole and the second through hole.

In order to solve the above-mentioned problems, another one of the technical aspects adopted by the present disclosure is to provide a charger device, which includes a casing, two conductive members, and a holder. The casing includes a first through hole, a second through hole, and a reinforcing rib structure. The first through hole and the second through hole are interconnected to an accommodating space inside the casing. The reinforcing rib structure is disposed inside the casing. The reinforcing rib structure includes a longitudinal rib, the longitudinal rib is disposed between the first through hole and the second through hole, and an extending direction of the longitudinal rib is parallel to a connecting line connecting the first through hole and the second through hole. The two conductive members pass through the first through hole and the second through hole. One end of the two conductive members is disposed inside the casing, and another end of the two conductive members is exposed outside the casing. The holder is disposed in the casing and holds the two conductive members.

Therefore, in the charger device and the casing with the reinforcing rib structure provided by the present disclosure, the longitudinal rib is provided between the first through hole and the second through hole and parallel to the connecting line connecting the first through hole and the second through hole, so that the second axial moment of area (also called the area moment of inertia) of the casing at the position can be increased. Comparing with existing charger devices that are provided with multiple structural ribs (e.g., at least three structural ribs) by using additional material, the charger device provided by the present disclosure requires only a single longitudinal rib, which can reduce material usage while increasing the overall structural strength, thereby improving the effectiveness of the reinforced rib structure.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic perspective view of a charger device according to a first embodiment of the present disclosure;

FIG. 2 is a schematic cross-sectional view taken along line II-II of FIG. 1;

FIG. 3 is a schematic perspective view of a casing according to the first embodiment of the present disclosure;

FIG. 4 is a schematic bottom view of the casing according to the first embodiment of the present disclosure;

FIG. 5 is a schematic cross-sectional view taken along line V-V of FIG. 3;

FIG. 6 is a schematic enlarged view of part VI of FIG. 5;

FIG. 7 is a schematic bottom view of a casing according to a second embodiment of the present disclosure;

FIG. 8 is a schematic cross-sectional view of the casing according to the second embodiment of the present disclosure;

FIG. 9 is a schematic bottom view of a casing according to a third embodiment of the present disclosure;

FIG. 10 is a schematic cross-sectional view of the casing according to the third embodiment of the present disclosure;

FIG. 11 is a schematic enlarged view of part XI of FIG. 10;

FIG. 12 is a schematic bottom view of a casing according to a fourth embodiment of the present disclosure;

FIG. 13 is a schematic cross-sectional view of the casing according to the fourth embodiment of the present disclosure;

FIG. 14 is a schematic bottom view of a casing according to a fifth embodiment of the present disclosure;

FIG. 15 is a schematic cross-sectional view of the casing according to the fifth embodiment of the present disclosure;

FIG. 16 is a schematic enlarged view of part XVI of FIG. 15;

FIG. 17 is a schematic bottom view of a casing according to a sixth embodiment of the present disclosure; and

FIG. 18 is a schematic cross-sectional view of the casing according to the sixth embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### First Embodiment

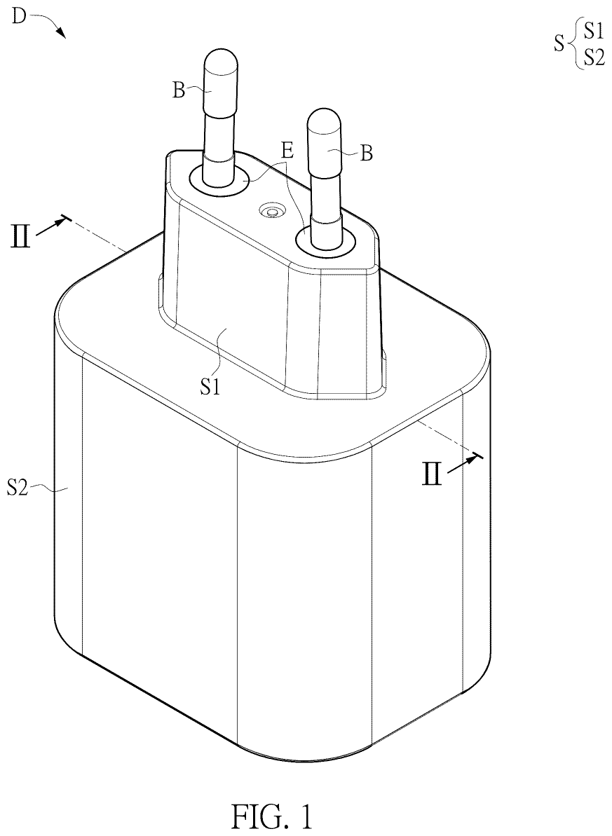

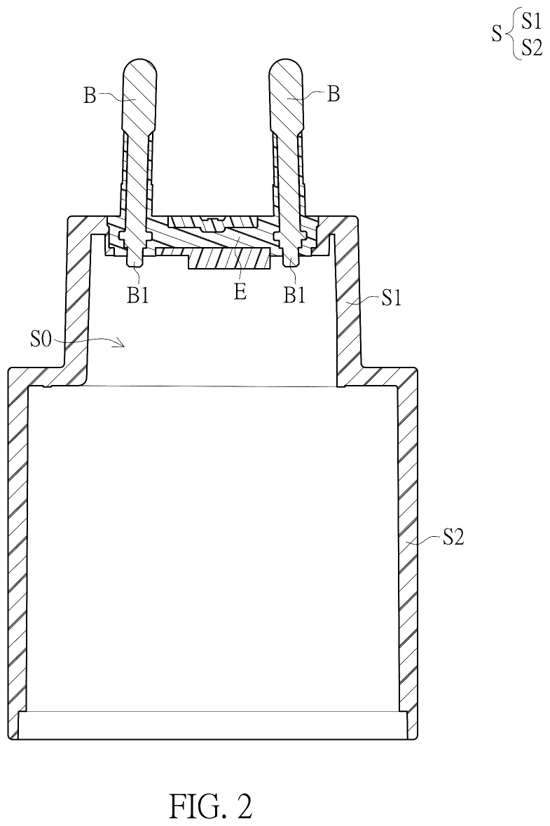

Reference is made to FIG. 1 and FIG. 2. FIG. 1 is a schematic perspective view of a charger device according to a first embodiment of the present disclosure. FIG. 2 is a schematic cross-sectional view taken along line II-II of FIG. 1. The first embodiment of the present disclosure provides a charger device D. The charger device D can be, for example, a charger that is suitable for game consoles. The charger device D includes a casing S and two conductive members B. The casing S includes a first part S1 and a second part S2, and the size of the first part S1 is smaller than that of the second part S2. The appearance and shape of the casing S are not limited in the present disclosure. Moreover, an interior of the casing S is hollow, and internal spaces of the first part S1 and the second part S2 are interconnected.

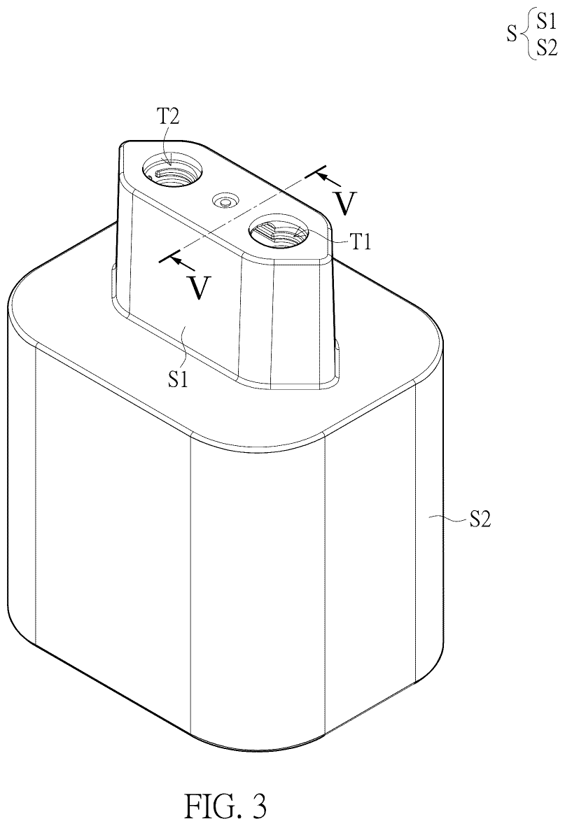

Reference is made to FIG. 2 and FIG. 3. FIG. 3 is a schematic perspective view of a casing according to the first embodiment of the present disclosure. The casing S further includes a first through hole T1 and a second through hole T2. The first through hole T1 and the second through hole T2 are provided at a top of the first part S1. The first through hole T1 and the second through hole T2 are interconnected to an accommodating space S0 inside the casing S. The two conductive members B pass through the first through hole T1 and the second through hole T2, respectively. One of the two conductive members B may pass through the first through hole T1, and the other of the two conductive members B may pass through the second through hole T2. One end B1 of the two conductive members B is disposed inside the casing S and connected to a metal spring (not shown in the figures), which is further electrically connected to other circuit elements through the metal spring to form a charging circuit, while another end of the two conductive members B is exposed outside the casing S to be connected to an external power source.

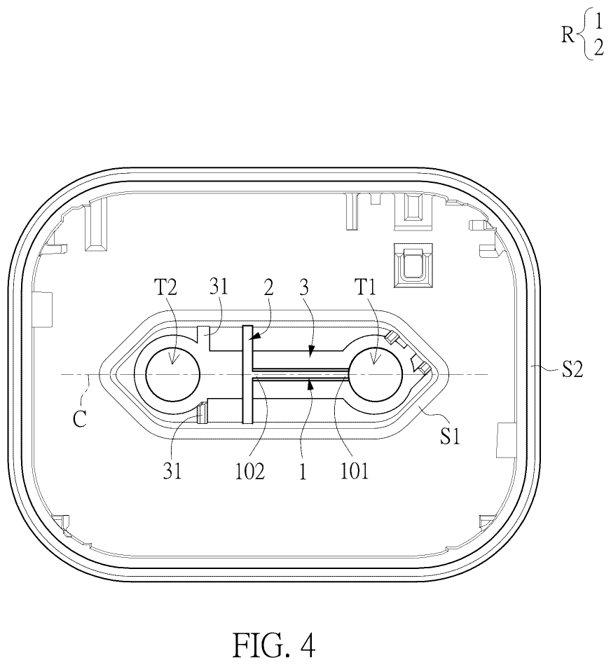

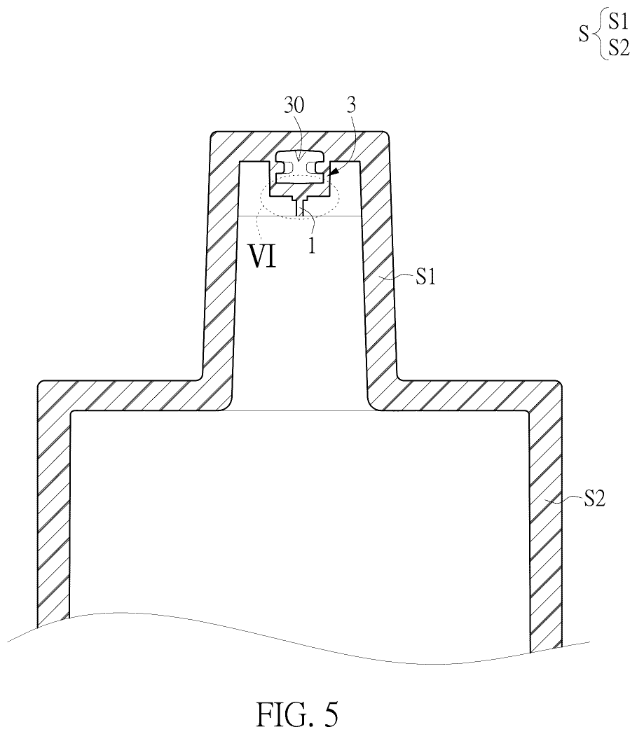

Reference is made to FIG. 3 to FIG. 5. FIG. 4 is a schematic bottom view of the casing according to the first embodiment of the present disclosure. FIG. 5 is a schematic cross-sectional view taken along line V-V of FIG. 3. The casing S is provided with a reinforcing rib structure R therein. The reinforcing rib structure R includes a longitudinal rib 1, and the longitudinal rib 1 is located between the first through hole T1 and the second through hole T2. More specifically, a connecting line C is defined between the first through hole T1 and the second through hole T2. The connecting line C passes through the first through hole T1 and the second through hole T2, and an extending direction of the longitudinal rib 1 is parallel to the connecting line C, as shown in FIG. 4.

The first part S1 of the casing S further includes a base 3 therein. The base 3 is disposed between the first through hole T1 and the second through hole T2. The reinforcing rib structure R is disposed on the base 3. In addition, the base 3 includes two connecting ribs 31 adjacent to the second through holes T2, and the two connecting ribs 31 abut against an inner wall of the first part S1. The base 3 is hollow inside and has a receiving cavity 30, and the receiving cavity 30 is interconnected to the first through hole T1 and the second through hole T2. The charger device D further includes a holder E that is disposed in the receiving cavity 30. The holder E extends toward the first through hole T1 and the second through hole T2. The holder E holds the two conductive members B, fixes the position of the two conductive members B and covers the two conductive members B.

As shown in FIG. 4, the reinforcing rib structure R further includes a transverse rib 2. The transverse rib 2 is disposed between the first through hole T1 and the second through hole T2. The transverse rib 2 is perpendicular to the longitudinal rib 1, and two ends of the transverse rib 2 extend in opposite directions and abut against the inner wall of the first part S1 of the casing S. The longitudinal rib 1 has a first end 101 and a second end 102. The first end 101 is connected to an edge of the first through hole T1, and the second end 102 is connected to the transverse rib 2. From the perspective in FIG. 4, the reinforcing rib structure R (i.e., the longitudinal rib 1 and the transverse rib 2) has a T-shape.

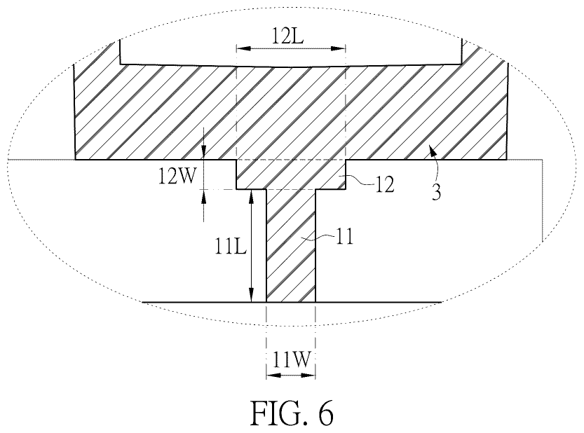

Reference is made to FIG. 5 and FIG. 6. FIG. 6 is a schematic enlarged view of part VI of FIG. 5. The cross-section shown in FIG. 5 is perpendicular to the connecting line C, so the longitudinal rib 1 also has a cross-section along the direction that is perpendicular to the connecting line C. As shown in FIG. 6, the cross-section of the longitudinal rib 1 has a T shape, and the T-shaped cross-section includes a vertical portion 11 and a horizontal portion 12. The vertical portion 11 and the horizontal portion 12 are both rectangular in shape. More specifically, a length 11L of the vertical portion 11 is greater than a length 12L of the horizontal portion 12, and a width 11W of the vertical portion 11 is greater than a width 12W of the horizontal portion 12. In a preferred embodiment, the length 11L of the vertical portion 11 is equal to 1.3 mm, the length 12L of the horizontal portion 12 is equal to 1.1 mm, the width 11W of the vertical portion 11 is equal to 0.5 mm, and the width 12W of the horizontal portion 12 is equal to 0.3 mm.

For example, the casing S including the reinforcing rib structure R is an integrally formed structure, and the constituent material of the casing S can be polycarbonate, while the constituent material of the holder E that is disposed in the receiving cavity 30 of the base 3 can be nylon. Since the structural strength of the holder E is weak, the reinforcing rib structure R (i.e., the longitudinal rib 1) is provided at the position of the base 3 to increase the area moment of inertia. The larger the area moment of inertia, the better the anti-deformation capability. Thereby, the overall structural strength of the charger device D can be enhanced.

### Second Embodiment

It should be noted that the charger device D provided in the following embodiments (i.e., the second to sixth embodiments) all include a casing S, two conductive members B, and a holder E, and the appearance of the charger device D and its housing S is the same as that of the first embodiment, as shown in FIGS. 1 and 3. The main difference lies in the different implementations of the reinforcing rib structure R inside the casing S. Therefore, the following embodiments only present the schematic bottom view and the schematic cross-sectional view of the casing S, focusing primarily on the differences in the reinforcing rib structure R.

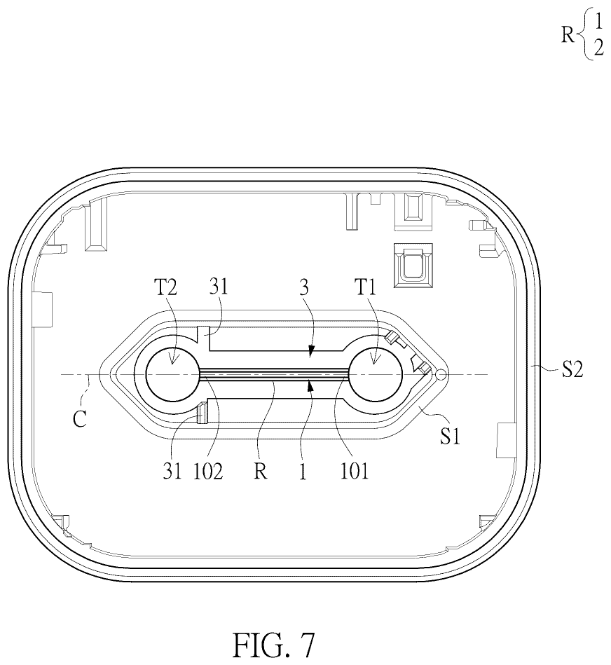

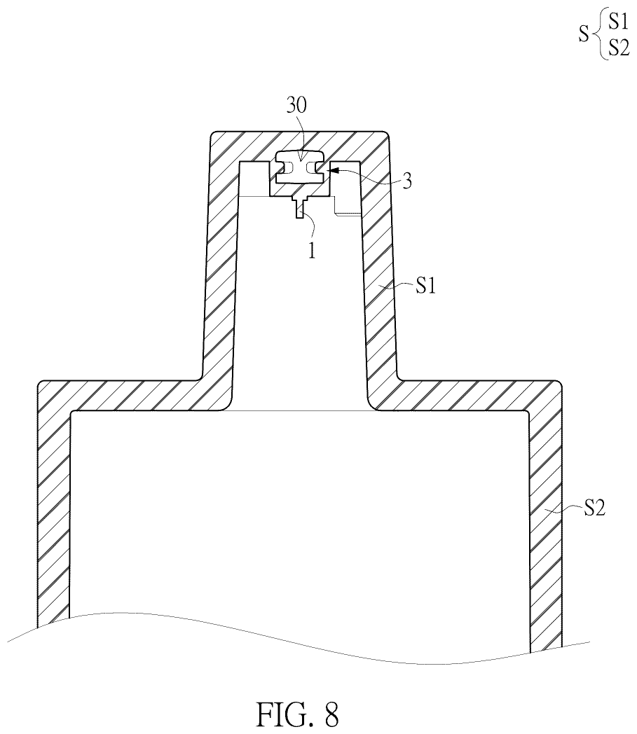

Reference is made to FIG. 7 and FIG. 8. FIG. 7 is a schematic bottom view of a casing according to a second embodiment of the present disclosure. FIG. 8 is a schematic cross-sectional view of the casing according to the second embodiment of the present disclosure. Comparing FIG. 4 of the first embodiment with FIG. 8 of the second embodiment, in FIG. 7, the reinforcing rib structure R inside the casing S only includes the longitudinal rib 1, but no transverse rib 2. As shown in FIG. 7, the cross-section of the longitudinal rib 1 of the reinforcing rib structure R has a T shape. It should be noted that, in the second embodiment, the effect achieved by using only the longitudinal rib 1 without the transverse rib 2 is better. Specifically, this configuration enhances overall structural strength and allows for greater material savings in manufacturing.

### Third Embodiment

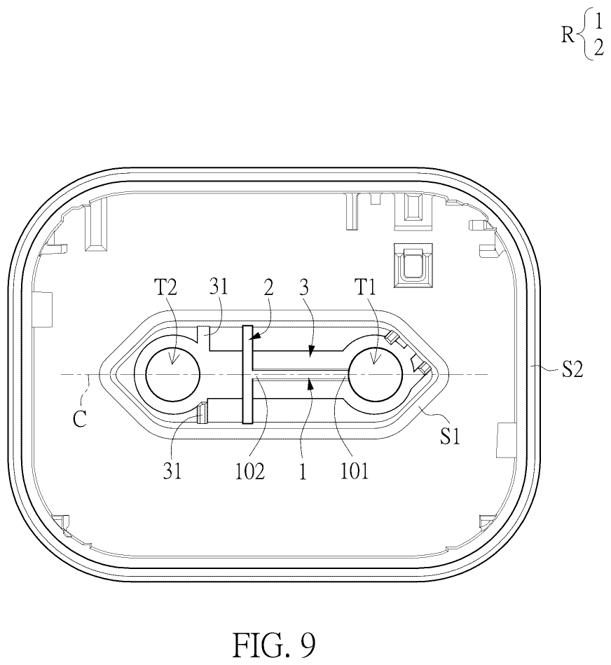

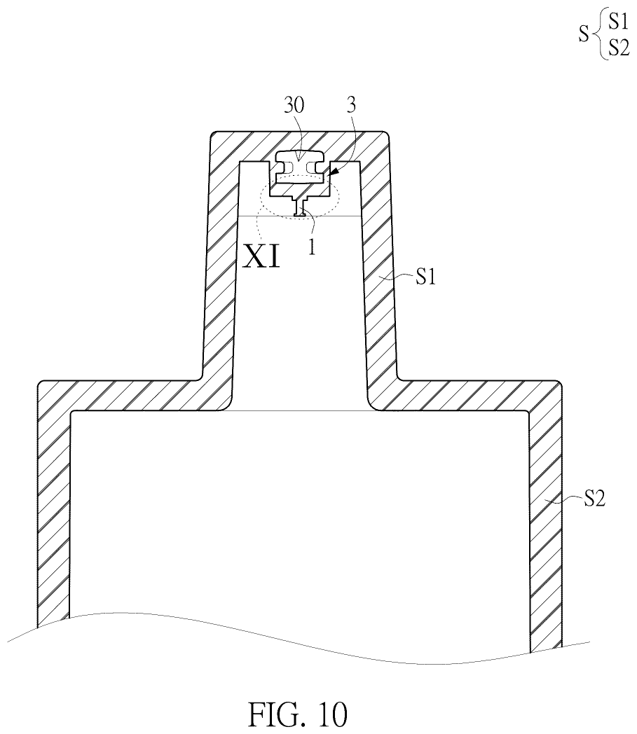

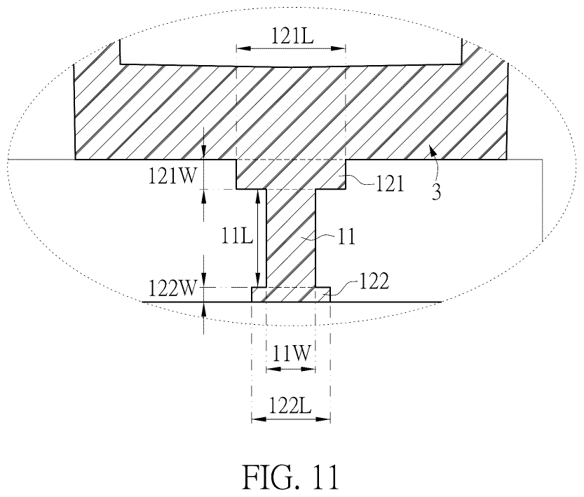

Reference is made to FIG. 9 to FIG. 11. FIG. 9 is a schematic bottom view of a casing according to a third embodiment of the present disclosure. FIG. 10 is a schematic cross-sectional view of the casing according to the third embodiment of the present disclosure. The perspective in FIG. 10 is the same as that in FIG. 5 and can be regarded as the cross-sectional view taken along line V-V of FIG. 3. FIG. 11 is a schematic enlarged view of part XI of FIG. 10. In the third embodiment, the reinforcing rib structure R inside the casing S includes a longitudinal rib 1 and a transverse rib 2.

The transverse rib 2 is disposed between the first through hole T1 and the second through hole T2. The transverse rib 2 is perpendicular to the longitudinal rib 1, and two ends of the transverse rib 2 extend in opposite directions to abut against an inner wall of the first part S1 of the casing S. A first end 101 of the longitudinal rib 1 is connected to an edge of the first through hole T1, and a second end 102 of the longitudinal rib 1 is connected to the transverse rib 2.

As shown in FIG. 9, the longitudinal rib 1 has a cross-section along a direction that is perpendicular to the connecting line C. As shown in FIG. 11, the cross-section is I-shaped. The I-shape cross-section of the longitudinal rib 1 includes a vertical portion 11, a first horizontal portion 121, and a second horizontal portion 122. The vertical portion 11 is vertically connected between the first horizontal portion 121 and the second horizontal portion 122. Each of the vertical portion 11, the first horizontal portion 121, and the second horizontal portion 122 is rectangular in shape.

The sizes of the vertical portion 11, the first horizontal portion 121, and the second horizontal portion 122 are different from each other. A length 121L of the first horizontal portion 121 is greater than a length 11L of the vertical portion 11, and a length 121L of the first horizontal portion 121 is greater than a length 122L of the second horizontal portion 122. A width 11W of the vertical portion 11 is greater than a width 121W of the first horizontal portion 121, and a width 121W of the first horizontal portion 121 is greater than a width 122W of the second horizontal portion 122. Moreover, a sum of a length 11L of the vertical portion 11 and a width 122W of the second horizontal portion 122 is greater than a length 121L of the first horizontal portion 121. In a preferred embodiment, the length 11L of the vertical portion 11 is equal to 1 mm, the length 121L of the first horizontal portion 121 is equal to 1.1 mm, the length 122L of the second horizontal portion 122 is equal to 0.8 mm, the width 11W of the vertical portion 11 is equal to 0.5 mm, the width 121W of the first horizontal portion 121 is equal to 0.3 mm, and the width 122W of the second horizontal portion 122 is equal to 0.15 mm.

### Fourth Embodiment

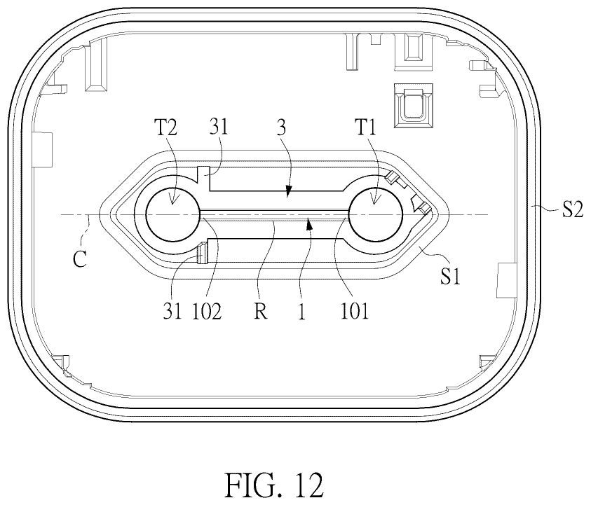

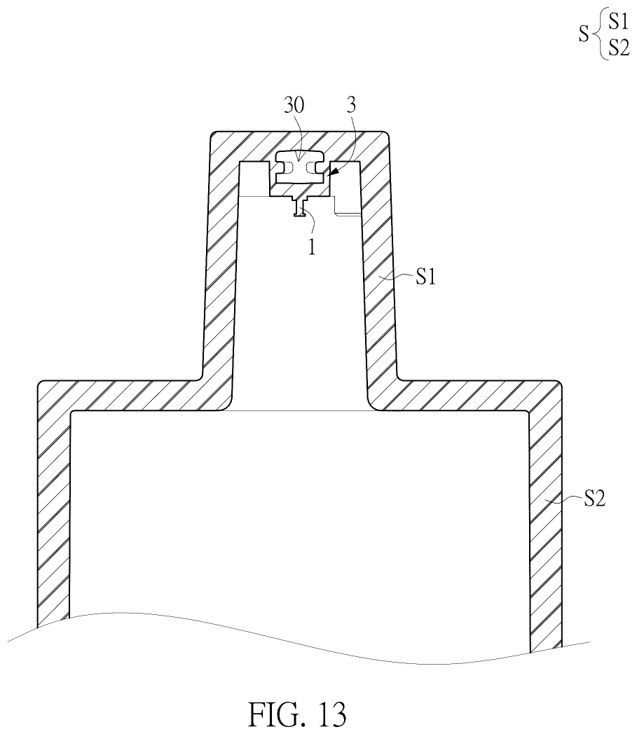

Reference is made to FIG. 12 and FIG. 13. FIG. 12 is a schematic bottom view of a casing according to a fourth embodiment of the present disclosure. FIG. 13 is a schematic cross-sectional view of the casing according to the fourth embodiment of the present disclosure. The perspective in FIG. 13 is the same as that in FIG. 5 and can be regarded as the cross-sectional view taken along line V-V of FIG. 3. Comparing FIG. 9 of the third embodiment with FIG. 12 of the fourth embodiment, in FIG. 12, the reinforcing rib structure R inside the casing S only includes the longitudinal rib 1, but no transverse rib 2. As shown in FIG. 13, the cross-section of the longitudinal rib 1 of the reinforcing rib structure R is I-shaped. It should be noted that, in the fourth embodiment, the effect achieved by using only the longitudinal rib 1 without the transverse rib 2 is better. Specifically, this configuration enhances overall structural strength and allows for greater material savings in manufacturing.

### Fifth Embodiment

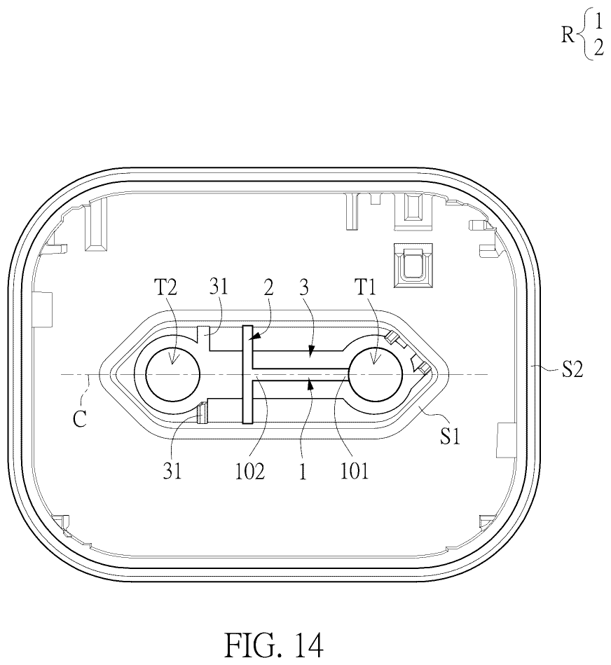

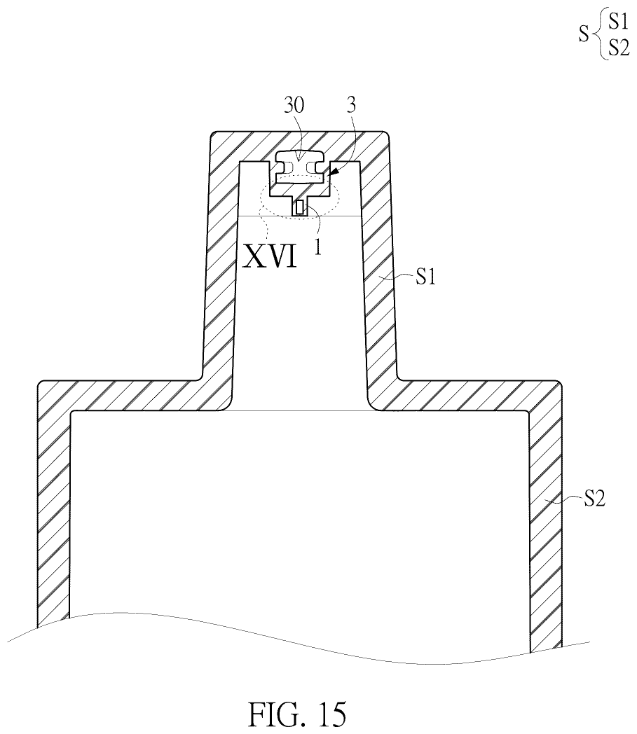

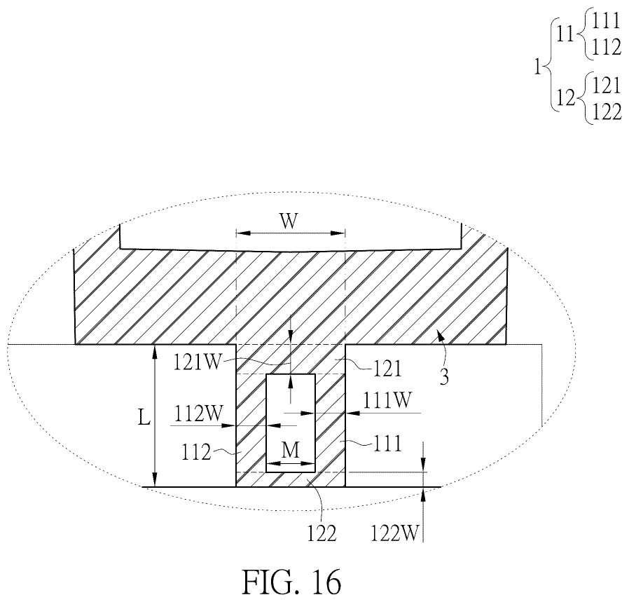

Reference is made to FIG. 14 to FIG. 16. FIG. 14 is a schematic bottom view of a casing according to a fifth embodiment of the present disclosure. FIG. 15 is a schematic cross-sectional view of the casing according to the fifth embodiment of the present disclosure. FIG. 16 is a schematic enlarged view of part XVI of FIG. 15. In the fifth Embodiment, the reinforcing rib structure R inside the casing S includes a longitudinal rib 1 and a transverse rib 2.

The transverse rib 2 is disposed between the first through hole T1 and the second through hole T2. The transverse rib 2 is perpendicular to the longitudinal rib 1, and two ends of the transverse rib 2 extend in opposite directions to abut against an inner wall of the first part S1 of the casing S. A first end 101 of the longitudinal rib 1 is connected to an edge of the first through hole T1, and a second end 102 of the longitudinal rib 1 is connected to the transverse rib 2.

As shown in FIG. 14, the longitudinal rib 1 has a cross-section along a direction that is perpendicular to the connecting line C. As shown FIG. 16, the cross-section has a hollow rectangular shape. In other words, the cross-section is a hollow rectangular cross-section. The longitudinal rib 1 is hollow, and the longitudinal rib 1 has a passage inside which penetrates the entire structure of the longitudinal rib 1. Through the structural design of the hollow rectangular cross-section of the longitudinal rib 1, the material costs can be can reduced, and the overall structural strength of the charger device D can be enhanced. The hollow rectangular cross-section of the longitudinal rib 1 includes a first horizontal portion 121, a second horizontal portion 122, a first vertical portion 111, and a second vertical portion 112. The first vertical portion 111 and the second vertical portion 112 are vertically connected to the first horizontal portion 121 and the second horizontal portion 122, and each of the first horizontal portion 121, the second horizontal portion 122, the first vertical portion 111, and the second vertical portion 112 has a rectangular shape.

As shown in FIG. 16, a width 111W of the first vertical portion 111 is greater than 18% of a length L of the hollow rectangular cross-section, and a width 112W of the second vertical portion 112 is greater than 18% of the length L of the hollow rectangular cross-section. A length ratio of the first vertical portion 111 and the second vertical portion 112 is greater than 18%. A width 121W of the first horizontal portion 121 is greater than a width 122W of the second horizontal portion 122. In addition, the width 121W of the first horizontal portion 121 is greater than 27% of a width W of the hollow rectangular cross-section. That is, a width ratio of the first horizontal portion 121 is greater than 27%. The width 122W of the second horizontal portion 122 is greater than 13% of the width W of the hollow rectangular cross-section. That is, a width ratio of the second horizontal portion 122 is greater than 13%. Furthermore, the width 111W of the first vertical portion 111 is greater than the width 122W of the second horizontal portion 122, the width 112W of the second vertical portion 112 is greater than the width 122W of the second horizontal portion 122, and the length L of the hollow rectangular cross-section is greater than the width W of the hollow rectangular cross-section. The first vertical portion 111 and the second vertical portion 112 have a distance M therebetween, the distance M is greater than the width 111W of the first vertical portion 111, and the distance M is greater than the width 112W of the second vertical portion 112. In a preferred embodiment, the length L of the hollow rectangular cross-section of the longitudinal rib 1 is equal to 1.6 mm, and the width W of the hollow rectangular cross-section is equal to 1.1 mm. The width 111W of the first vertical portion 111 is equal to 0.3 mm, the width 112W of the second vertical portion 112 is equal to 0.3 mm, the width 121W of the first horizontal portion 121 is equal to 0.3 mm, the width 122W of the second horizontal portion 122 is equal to 0.15 mm, and the distance M is equal to the width W minus the width 111W and the width 112W, which is 0.5 mm.

### Sixth Embodiment

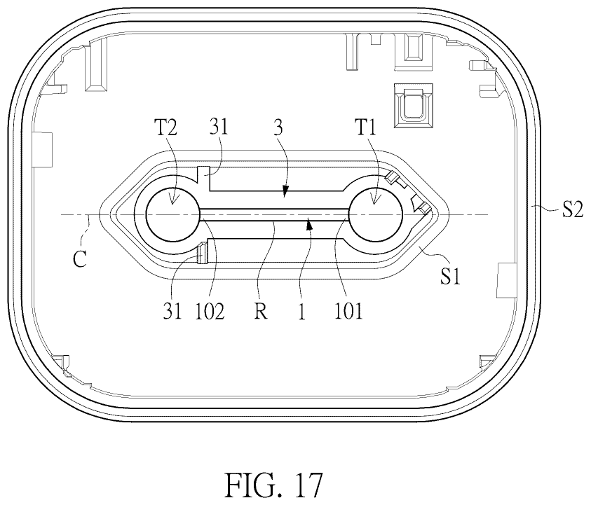

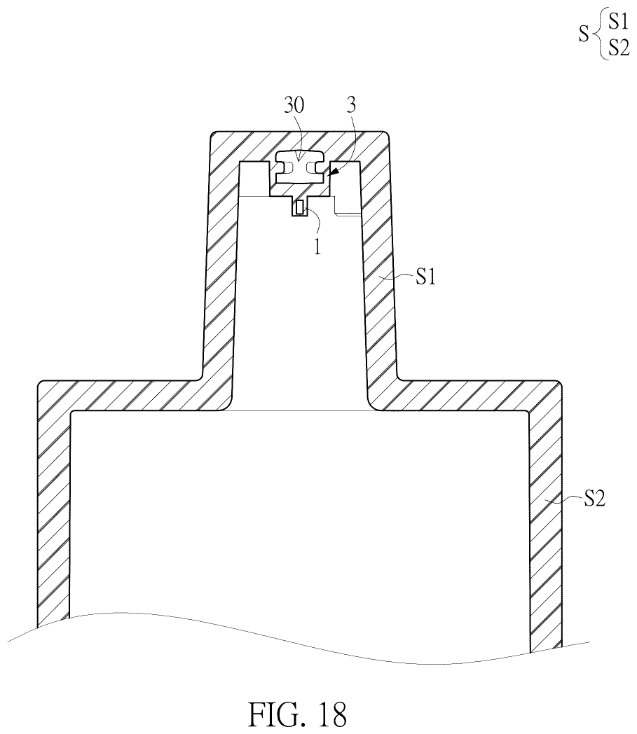

Reference is made to FIG. 17 and FIG. 18. FIG. 17 is a schematic bottom view of a casing according to a sixth embodiment of the present disclosure. FIG. 18 is a schematic cross-sectional view of the casing according to the sixth embodiment of the present disclosure. The perspective in FIG. 18 is the same as that in FIG. 5 and can be regarded as the cross-sectional view taken along line V-V of FIG. 3. Comparing FIG. 14 of the fifth embodiment with FIG. 17 of the sixth embodiment, in FIG. 17, the reinforcing rib structure R inside the casing S only includes the longitudinal rib 1, but no transverse rib 2. As shown in FIG. 18, the cross-section of the longitudinal rib 1 of the reinforcing rib structure R has a hollow rectangular shape. It should be noted that, in the sixth embodiment, the effect achieved by using only the longitudinal rib 1 without the transverse rib 2 is better. Specifically, this configuration enhances overall structural strength and allows for greater material savings in manufacturing.

### Beneficial Effects of the Embodiments

To enhance the structural strength of existing charging devices, it is common to directly add more structural ribs, particularly increasing the quantity of transverse ribs (e.g., at least two transverse ribs). In other words, the existing charging devices improve the structural strength by increasing the quantity of the transverse ribs. However, while adding more structural ribs can enhance the structural strength, it increases manufacturing costs due to the additional material usage. In contrast, in the charger device D and the casing S with the reinforcing rib structure provided by the present disclosure, the longitudinal rib 1 is provided between the first through hole T1 and the second through hole T2 and parallel to the connecting line C connecting the first through hole T1 and the second through hole T2, so that the area moment of inertia of the casing S at the position can be increased. The larger the area moment of inertia, the better the anti-deformation capability. Thereby, the overall structural strength of the charger device D can be enhanced. Comparing with existing charger devices, the charger device D provided by the present disclosure requires only a single longitudinal rib, which can reduce material usage while increasing the overall structural strength, thereby improving the effectiveness of the reinforced rib structure.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A casing with a reinforcing rib structure for a charger device, comprising:
a first through hole and a second through hole, wherein the first through hole and the second through hole are interconnected to an accommodating space inside the casing; and
a reinforcing rib structure disposed inside the casing, wherein the reinforcing rib structure comprises a longitudinal rib, the longitudinal rib is disposed between the first through hole and the second through hole, and an extending direction of the longitudinal rib is parallel to a connecting line connecting the first through hole and the second through hole.

2. The casing with the reinforcing rib structure according to claim 1, wherein the reinforcing rib structure further comprises a transverse rib, the transverse rib is disposed between the first through hole and the second through hole, the transverse rib is perpendicular to the longitudinal rib, the longitudinal rib has a first end and a second end, the first end is connected to an edge of the first through hole, and the second end is connected to the transverse rib.

3. The casing with the reinforcing rib structure according to claim 1, wherein the longitudinal rib has a first end and a second end, the first end is connected to a side of the first through hole, and the second end is connected to a side of the second through hole.

4. The casing with the reinforcing rib structure according to claim 1, wherein the longitudinal rib has a cross-section along a direction that is perpendicular to the connecting line, the cross-section includes a vertical portion and a horizontal portion, and a length of the vertical portion is greater than a length of the horizontal portion.

5. The casing with the reinforcing rib structure according to claim 4, wherein a width of the vertical portion is greater than a width of the horizontal portion.

6. The casing with the reinforcing rib structure according to claim 5, wherein each of the vertical portion and the horizontal portion has a rectangular shape.

7. The casing with the reinforcing rib structure according to claim 1, wherein the longitudinal rib has a cross-section along a direction that is perpendicular to the connecting line, the cross-section includes a vertical portion, a first horizontal portion, and a second horizontal portion, and the vertical portion is vertically connected between the first horizontal portion and the second horizontal portion.

8. The casing with the reinforcing rib structure according to claim 7, wherein each of the vertical portion, the first horizontal portion, and the second horizontal portion has a rectangular shape.

9. The casing with the reinforcing rib structure according to claim 7, wherein a length of the first horizontal portion is greater than a length of the vertical portion, and a length of the first horizontal portion is greater than a length of the second horizontal portion.

10. The casing with the reinforcing rib structure according to claim 7, wherein a width of the vertical portion is greater than a width of the first horizontal portion, and a width of the first horizontal portion is greater than a width of the second horizontal portion.

11. The casing with the reinforcing rib structure according to claim 7, wherein a sum of a length of the vertical portion and a width of the second horizontal portion is greater than a length of the first horizontal portion.

12. The casing with the reinforcing rib structure according to claim 1, wherein the longitudinal rib has a cross-section along a direction that is perpendicular to the connecting line, the cross-section has a hollow rectangular shape.

13. The casing with the reinforcing rib structure according to claim 12, wherein the cross-section includes a first horizontal portion, a second horizontal portion, a first vertical portion, and a second vertical portion, the first vertical portion and the second vertical portion are vertically connected to the first horizontal portion and the second horizontal portion, and each of the first horizontal portion, the second horizontal portion, the first vertical portion, and the second vertical portion has a rectangular shape.

14. The casing with the reinforcing rib structure according to claim 13, wherein a length of the cross-section is greater than a width of the cross-section.

15. The casing with the reinforcing rib structure according to claim 13, wherein a width of the first horizontal portion is greater than a width of the second horizontal portion.

16. The casing with the reinforcing rib structure according to claim 13, wherein a width of the first vertical portion is greater than a width of the second horizontal portion, and a width of the second vertical portion is greater than the width of the second horizontal portion.

17. The casing with the reinforcing rib structure according to claim 13, wherein the first vertical portion and the second vertical portion have a distance therebetween, the distance is greater than a width of the first vertical portion, and the distance is greater than a width of the second vertical portion.

18. The casing with the reinforcing rib structure according to claim 1, further comprising a base, the base is disposed between the first through hole and the second through hole, the base is hollow and has a receiving cavity, the receiving cavity is interconnected to the first through hole and the second through hole, and the reinforcing rib structure is arranged on the base.

19. A charger device, comprising:
a casing comprising:
a first through hole and a second through hole, wherein the first through hole and the second through hole are interconnected to an accommodating space inside the casing; and
a reinforcing rib structure disposed inside the casing, wherein the reinforcing rib structure comprises a longitudinal rib, the longitudinal rib is disposed between the first through hole and the second through hole, and an extending direction of the longitudinal rib is parallel to a connecting line connecting the first through hole and the second through hole;
two conductive members passing through the first through hole and the second through hole, wherein one end of the two conductive members is disposed inside the casing, and another end of the two conductive members is exposed outside the casing; and
a holder disposed in the casing and holding the two conductive members.
